(19) United States
(12) Patent Application Publication
(10) Pub. No.: US 2013/0128074 A1
(43) Pub. Date: May 23, 2013

(54) DISPLAY UNIT, IMAGE SENSING UNIT AND DISPLAY SYSTEM

(71) Applicant: Tatsuya Mitsugi, Tokyo (JP)

(72) Inventor: Tatsuya Mitsugi, Tokyo (JP)

(73) Assignee: MITSUBISHI ELECTRIC CORPORATION, Tokyo (JP)

(21) Appl. No.: 13/813,367

(22) PCT Filed: Nov. 19, 2010
(86) PCT No.: PCT/JP2010/006800

§ 371 Date: Jan. 30, 2013

(51) Int. Cl. H04N 5/232; H04N 9/73

(52) U.S. Cl. CPC H04N 5/23293; H04N 9/735
USPC 348/223.1; 348/333.01

(57) ABSTRACT

A host unit 3 includes a display-side communication section 30 for carrying out communication with a camera unit 2; a display control section 33 for displaying on a display panel 34 an image or video taken with an image sensor 20, which is received from the camera unit 2 via the display-side communication section 30, in accordance with a display video parameter that prescribes image quality of the image or video to be displayed on the display panel 34; and a display video parameter control section 31 for controlling, when receiving a control instruction from a camera video parameter alteration extraction section 23 via the display-side communication section 30, the display video parameter according to the altered contents of the camera video parameter, wherein the display video parameter corresponds to the camera video parameter the control instruction designates.

### TECHNICAL FIELD

The present invention relates to an image sensing unit having an image sensing section, a display unit having a display section for displaying an image or video taken with the image sensing section, and a display system comprising them.

### BACKGROUND ART

For example, a conventional display system described in a Patent Document 1 comprises on a display unit side an image quality optimization processing section that includes a connected device recognition section for detecting an image sensing device of an image sensing unit and an information acquiring section for gaining from the outside the information for obtaining matching with the image sensing device; and a control section for optimizing a video signal supplied from the image sensing device and for causing the display device to display it by referring to the information for obtaining matching with the image sensing device, which information is acquired by the image quality optimization processing section, thereby being able to display a video which is improved in its quality by considering the characteristics of the image sensing device and display device and the shooting information.

### PRIOR ART DOCUMENT

### Patent Document

Patent Document 1: Japanese Patent Laid-Open No. 2007-178831.

### DISCLOSURE OF THE INVENTION

### Problems to be Solved by the Present Invention

In the conventional technique typified by the Patent Document 1, the display device of the display unit optimizes the quality of the video taken with the image sensing device by acquiring, from an external server, information about video settings such as a dynamic range and contrast ratio in accordance with the model of the image sensing device detected by the connected device recognition section. In addition, according to weather information acquired from the server as additional information, it carries out optimization processing of the video signal taken with the image sensing device by considering parameters such as white balance and exposure in accordance with the weather.

Thus, the conventional technique does not cause the image sensing device of the image sensing unit to obtain matching of the parameters that prescribe image sensing conditions, which undergo automatic control at the image sensing and define the image quality, with the parameters that prescribe image quality of the video displayed on the display device of the display unit. Accordingly, when factors such as illuminance, which will affect an image taken in the surrounding environment of the image sensing unit, vary moment by moment, even the same object appears differently depending on the display device, offering a problem in that it is likely that it cannot display the optimum video. For example, even the same input video that is displayed on the display device can sometimes appear differently because of variations in the illuminance of the surrounding environment with the movement of the vehicle.

The present invention is implemented to solve the foregoing problems. Therefore it is an object of the present invention to provide a display unit, an image sensing unit and a display system capable of enabling the display section of the display unit to appropriately display, when the parameters that prescribe image sensing conditions of an image or video taken with the image sensing section and that prescribe the image quality are altered because of changes in the surrounding environment of the image sensing unit, the image or video which is taken with the image sensing section of the image sensing unit by controlling the parameters that prescribe the image quality of the image or video to be displayed on the display section of the display unit in accordance with the alteration.

### Means for Solving the Problem

A display system in accordance with the present invention comprises: an image sensing unit including an image sensing section for taking an image or video, an image sensing-side control section for altering an image sensing-side parameter that prescribes image sensing conditions and image quality of the image or video of the image sensing section according to changes in a surrounding environment and for controlling image sensing of the image sensing section in accordance with the image sensing-side parameter, and an alteration extraction section for extracting the image sensing-side parameter, which has been altered by the image sensing-side control section, and altered contents, and for issuing a control instruction in accordance with the alteration of the image sensing-side parameter; and a display unit including a communication section for carrying out communication with the image sensing unit, a display-side control section for displaying the image or video, which is taken with the image sensing section and is received from the image sensing unit via the communication section, on a display section in accordance with the display-side parameter that prescribes image quality of the image or video the display section displays, and a control section for controlling, when receiving the control instruction from the alteration extraction section via the communication section, the display-side parameter according to the altered contents of the image sensing-side parameter, wherein the display-side parameter corresponds to the image sensing-side parameter the control instruction designates.

### Advantages of the Present Invention

According to the present invention, it has an advantage of being able to display the image or video taken with the image sensing unit on the display section of the display unit appropriately even if the surrounding environment of the image sensing unit changes.

### BRIEF DESCRIPTION OF THE DRAWINGS

FIG. 1 is a block diagram showing a configuration of a display system of the embodiment 1 in accordance with the present invention;

FIG. 2 is a block diagram showing a configuration of the camera control section in FIG. 1;

FIG. 3 is a block diagram showing a configuration of the display control section in FIG. 1;

FIG. 4 is a flowchart showing a flow of alteration and extraction of camera video parameters with a camera unit;

FIG. 5 is a flowchart showing a flow of the control instruction processing of the camera video parameters with the camera unit;

FIG. 6 is a flowchart showing a flow of the control processing of the display video parameters by the host unit; and

FIG. 7 is a diagram showing an example of corresponding data indicating correspondence between the camera video parameters and the display video parameters.

### BEST MODE FOR CARRYING OUT THE INVENTION

The best mode for carrying out the invention will now be described with reference to the accompanying drawings to explain the present invention in more detail.

### Embodiment 1

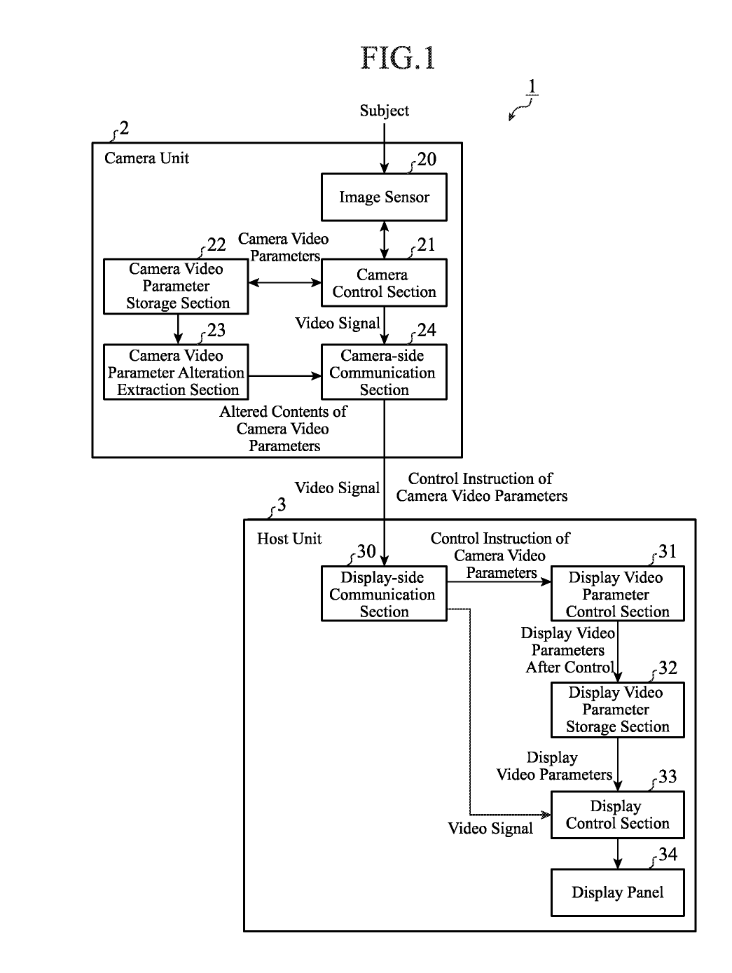

FIG. 1 is a block diagram showing a configuration of the display system of the embodiment 1 in accordance with the present invention. In FIG. 1, the display system 1 of the embodiment 1 comprises a camera unit (image sensing unit) 2 and a host unit (display unit) 3, and the host unit 3 carries out video display simultaneously with taking a video by the camera unit 2. The camera unit 2 comprises an image sensor (image sensing section) 20, a camera control section (image sensing-side control section) 21, a camera video parameter storage section 22, a camera video parameter alteration extraction section (alteration extraction section) 23, and a camera-side communication section (communication section) 24. In addition, the host unit 3 comprises a display-side communication section (communication section) 30, a display video parameter control section (control section) 31, a display video parameter storage section 32, a display control section (display-side control section) 33 and a display panel (display section) 34.

The image sensor 20, which is an image sensing device installed in the camera unit 2, employs a device such as a CCD (Charge Coupled Device) or CMOS (Complementary Metal Oxide Semiconductor) image sensor. Incidentally, the camera unit 2 can include a plurality of image sensors 20. For example, a configuration is also possible which has two image sensors 20 at the left and right of the camera unit 2 for taking a left-eye image and a right-eye image to acquire a 3D image or video.

The camera control section 21, which is a component for controlling image sensing of the image sensor 20, controls the image sensing of the image sensor 20 in accordance with image sensing conditions of an image or video of the image sensor 20 and with parameters that prescribe its image quality (referred to as “camera video parameters” from now on) (image sensing-side parameters).

Incidentally, the image sensing conditions of the video, on which the camera control section 21 carries out automatic control according to the surrounding environment at the image sensing, includes AE (Automatic Exposure) setting, AWB (Automatic White Balance) setting, AGC (Automatic Gain Control) setting, and BLC (Black Level Control) setting. The parameters that prescribe the image quality of an image taken includes gamma curve control, filter processing switching, contour emphasis step number switching, HUE control, saturation control, contrast control, sharpness control, shading control and white-black level control. The parameters vary depending on the type of the image sensor 20, and its resolution differs as well.

The camera video parameter storage section 22, which is a storage section for storing camera video parameters, is constructed as a memory readable from the camera control section 21. In addition, the camera video parameter storage section 22 stores the camera video parameters that undergo control (alteration) by the camera control section 21 according to the surrounding environment at the image sensing by the camera unit 2.

The camera video parameter alteration extraction section 23, which is a component for extracting altered contents of the camera video parameters altered according to the surrounding environment of the camera unit 2, transmits the altered contents of the camera video parameters obtained as a result of the extraction to the host unit 3 via the camera-side communication section 24 at the image sensing of the camera unit 2.

The camera-side communication section 24, which is a wire or wireless communication means, is a component for carrying out communication with the host unit 3. In addition, the display-side communication section 30 of the host unit 3, which is a wire or wireless communication means, is a component for carrying out communication with the camera unit 2. As for a communication scheme of the camera-side communication section 24 and the display-side communication section 30, although it can be wire communication connecting between them with a cable, it is also possible to use a mobile phone, wireless LAN (Local Area Network), or Bluetooth (registered trademark).

The display video parameter control section 31 is a component for controlling parameters that prescribe the image quality of the image or video to be displayed by a display panel 34 (referred to as “display video parameters”) (display-side parameters) according to the altered contents of the camera video parameters received from the camera unit 2.

Incidentally, the display video parameters includes automatic color control, white peak control, gamma peak control, noise compression control, color contour correction, luminance contour correction, HUE control, saturation control, contrast control, sharpness control, and backlight dimming. In addition, the color space and resolution differ depending on the type of the display panel 34.

The display video parameter storage section 32, which is a storage section for storing the display video parameters, is constructed as a memory readable from a display control section 33. In addition, the display video parameter storage section 32 stores the display video parameters that undergo the control of the display video parameter control section 31.

The display control section 33, which is a component for controlling video display of the display panel 34, controls the video display by the display panel 34 using the display video parameters read out of the display video parameter storage section 32. The display panel 34 is a display device for displaying a video taken with the camera unit 2. As the display panel 34 of the embodiment 1, a liquid crystal display panel capable of controlling the brightness of the screen by dimming its backlight is used.

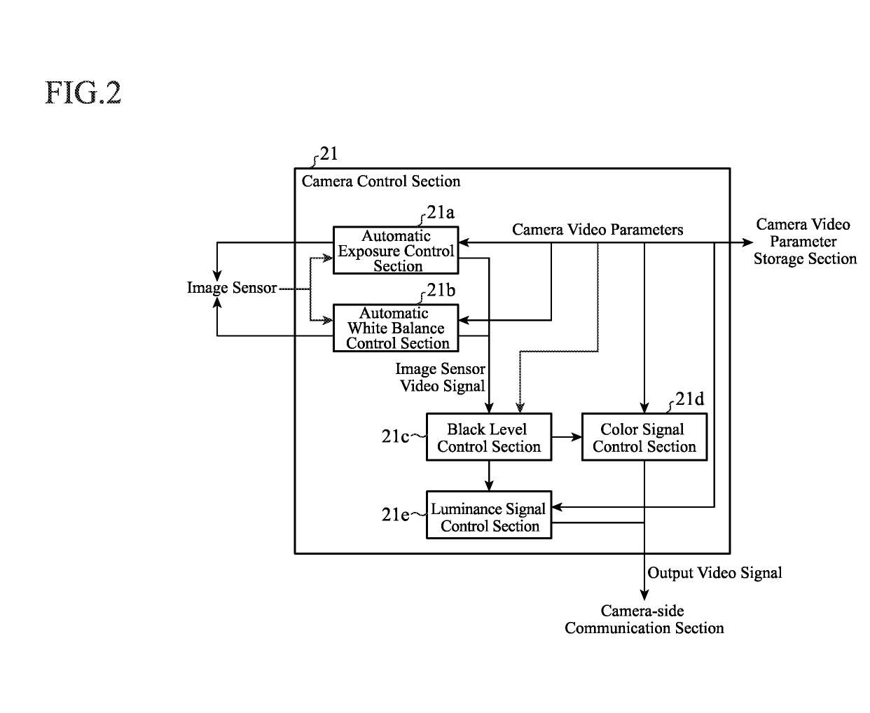

FIG. 2 is a block diagram showing a configuration of the camera control section of FIG. 1. In FIG. 2, the camera control section 21 comprises an automatic exposure control section 21a, an automatic white balance control section 21b, a black level control section 21c, a color signal control section 21d and a luminance signal control section 21e.

The automatic exposure control section 21a, which is a component for carrying out automatic exposure control in the image sensing of the image sensor 20, alters the exposure area, the brightness of the convergence value of the exposure, and the rate of change with respect to time to the brightness of the convergence value by controlling the camera video parameters concerning the automatic exposure control in response to the video signal taken with the image sensor 20 and/or to the detection signal of the illuminance sensor installed near the image sensor 20. The camera video parameters concerning the automatic exposure control after the control are stored from the automatic exposure control section 21a to the camera video parameter storage section 22.

The automatic white balance control section 21b is a component for carrying out automatic white balance control of the image sensing of the image sensor 20. For example, it analyzes the video signal taken with the image sensor 20 and alters the camera video parameters concerning the automatic white balance control, thereby controlling a balance area, a color space to be converged, and the rate of change with respect to time to the color space to be converged.

The black level control section 21c is a component for controlling the black level in the video signal passing through the control by the automatic exposure control section 21a and the automatic white balance control section 21b. For example, it analyzes the luminance of the black portion designated by the video signal taken with the image sensor 20 and alters the camera video parameter concerning the black level control, thereby controlling to an appropriate black level.

The color signal control section 21d is a component for controlling the color signal in the video signal taken with the image sensor 20. For example, it analyzes the color signal of the video signal taken with the image sensor 20 and alters the camera video parameters concerning the color signal control, thereby controlling to an appropriate color signal.

The luminance signal control section 21e is a component for controlling the luminance signal in the video signal taken with the image sensor 20. For example, it analyzes the luminance signal of the video signal whose black level is controlled by the black level control section 21c, and alters the camera video parameters concerning the luminance signal control, thereby controlling to an appropriate luminance signal. The color signal controlled by the color signal control section 21d and the video signal containing the luminance signal controlled by the luminance signal control section 21e are transmitted to the host unit 3 via the camera-side communication section 24.

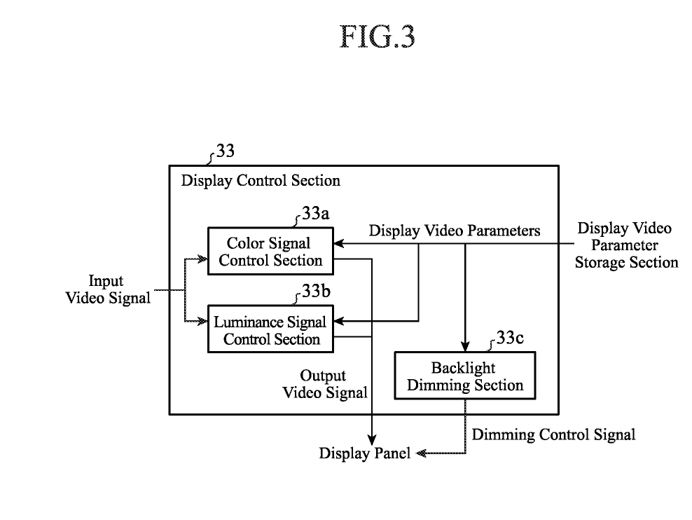

FIG. 3 is a block diagram showing a configuration of the display control section in FIG. 1. In FIG. 3, the display control section 33 comprises a color signal control section 33a, a luminance signal control section 33b and a backlight dimming section 33c. The color signal control section 33a is a component for controlling the color signal in the video signal received from the camera unit 2. It controls the color signal of the video signal to be displayed on the display panel 34 according to the display video parameters concerning the color signal control.

The luminance signal control section 33b is a component for controlling the luminance signal in the video signal received from the camera unit 2. It controls the luminance signal of the video signal to be displayed on the display panel 34 according to the display video parameters concerning the luminance signal control. Incidentally, the display panel 34 carries out the video display of the video signal containing the color signal controlled by the color signal control section 33a and the luminance signal controlled by the luminance signal control section 33b. The backlight dimming section 33c is a component for dimming the backlight of the display panel 34 according to the display video parameter concerning the backlight dimming.

Next, the operation will be described.

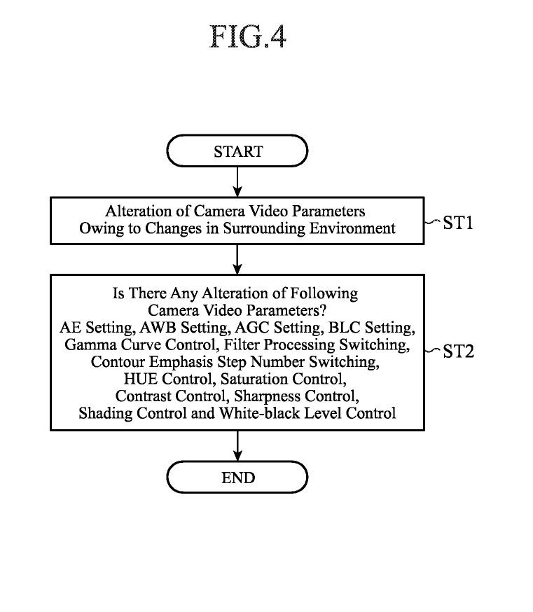

FIG. 4 is a flowchart showing a flow of the alteration and extraction of the camera video parameters by the camera unit of the embodiment 1.

In the image sensing with the camera unit 2, the automatic exposure control section 21a of the camera control section 21 carries out the automatic exposure control of the image sensor 20 in accordance with the camera video parameters concerning the automatic exposure control, which prescribe the exposure area, the brightness of the convergence value of the exposure, and the rate of change with respect to time to the brightness of the convergence value, thereby obtaining an appropriate exposure state.

In addition, the automatic white balance control section 21b carries out the automatic white balance control of the image sensor 20 in accordance with the camera video parameters concerning the automatic white balance control, which prescribe the balance area, the color space to be converged and the rate of change with respect to time to the color space to be converged, thereby obtaining the appropriate color state.

Furthermore, the black level control section 21c, color signal control section 21d and luminance signal control section 21e carry out the control of the video signal that passes through the control by the automatic exposure control section 21a and automatic white balance control section 21b in accordance with the camera video parameters concerning the individual control, and transmit the video signal after the control to the host unit 3 via the camera-side communication section 24.

In a series of processing described above, when the brightness of the surrounding environment of the camera unit 2 varies, the automatic exposure control section 21a alters the camera video parameters concerning the automatic exposure control according to the variations in the brightness, carries out the automatic exposure control of the image sensor 20 in accordance with the camera video parameters after the alteration, and obtains the exposure state corresponding to the surrounding environment of the camera unit 2. Likewise, the automatic white balance control section 21b alters the camera video parameters concerning the automatic white balance control according to the variations in the brightness, and carries out the automatic white balance control of the image sensor 20 in accordance with the camera video parameters after the alteration. The camera video parameters after the alteration are stored in the camera video parameter storage section 22. The alteration processing of the camera video parameters as described above corresponds to step ST1.

The camera video parameter alteration extraction section 23 monitors the alteration of the camera video parameters stored in the camera video parameter storage section 22, and extracts the altered camera video parameters when detecting alteration of the camera video parameters (step ST2).

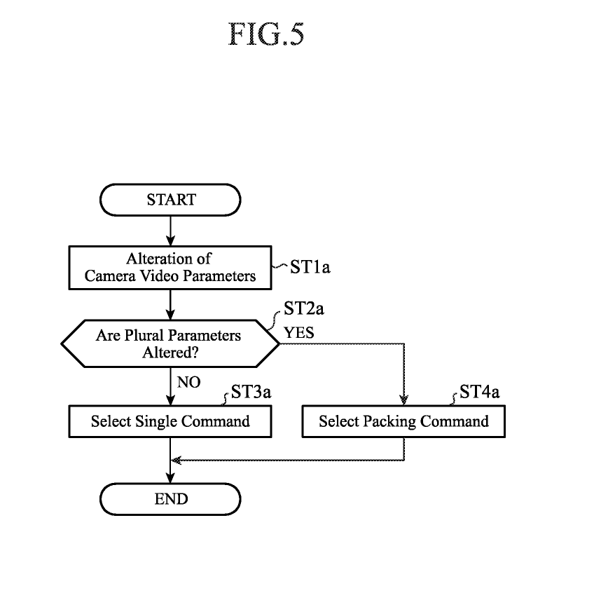

FIG. 5 is a flowchart showing a flow of the control instruction processing of the camera video parameters by the camera unit 2 of the embodiment 1.

When the camera video parameter alteration extraction section 23 detects the alteration of the camera video parameters stored in the camera video parameter storage section 22, it extracts the altered camera video parameters (step ST1a).

Next, the camera video parameter alteration extraction section 23 decides on whether a plurality of camera video parameters are altered or not (step ST2a). Unless a plurality of camera video parameters are altered (NO at step ST2a), the camera video parameter alteration extraction section 23 selects a single command that instructs the display video parameter control in response to the single camera video parameter altered (step ST3a). The selected single command is transmitted to the host unit 3 via the camera-side communication section 24.

On the other hand, when a plurality of camera video parameters are altered (YES at step ST2a), the camera video parameter alteration extraction section 23 selects a packing command that packs and abstracts a plurality of commands for instructing the display video parameter control in response to the plurality of camera video parameters altered (step ST4a). The selected packing command is transmitted to the host unit 3 via the camera-side communication section 24.

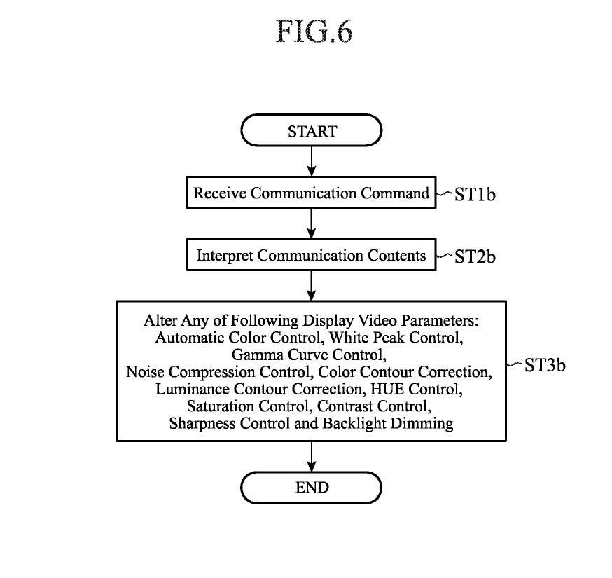

FIG. 6 is a flowchart showing a flow of the control processing of the display video parameters by the host unit of the embodiment 1.

In the host unit 3, when the display-side communication section 30 receives the video signal from the camera unit 2 through communication with the camera-side communication section 24, the color signal control section 33a of the display control section 33 controls the color signal of the input video signal in accordance with the display video parameters concerning the color signal. In addition, the luminance signal control section 33b controls the luminance signal of the input video signal in accordance with the display video parameters concerning the luminance signal. The video signal thus controlled is supplied to the display panel 34.

Furthermore, the backlight dimming section 33c dims the backlight of the display panel 34 in accordance with the display video parameter concerning the backlight dimming, thereby controlling the total brightness of the display panel 34.

Incidentally, since the color space and resolution are different depending on the type of the display panel 34, the color signal control section 33a, luminance signal control section 33b and backlight dimming section 33c carry out the control processing in accordance with the display video parameters corresponding to the type of the display panel 34.

In the series of the processing described above, when the display-side communication section 30 receives the communication command instructing to alter the display video parameters from the camera unit 2 (step ST1b), the display-side communication section 30 supplies the communication command to the display video parameter control section 31.

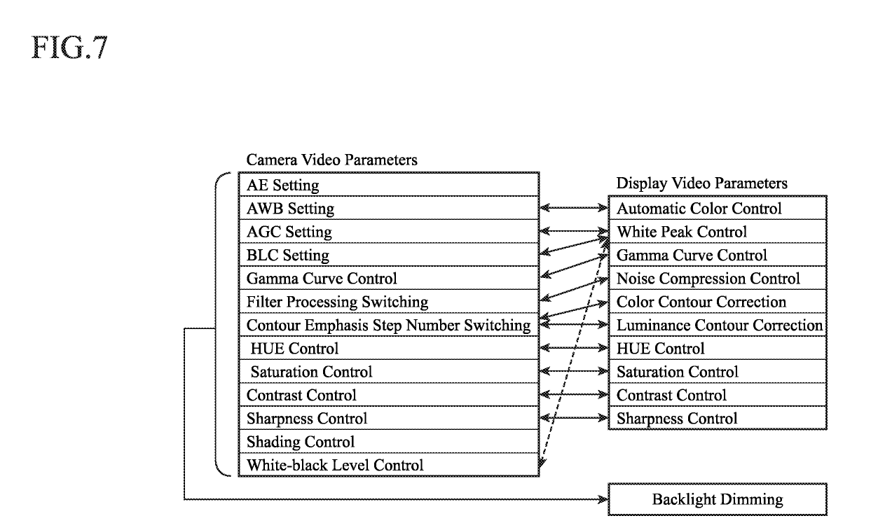

The display video parameter control section 31 interprets the contents of the communication command acquired via the display-side communication section 30 by referring to the corresponding data that will be described later with reference to FIG. 7, thereby identifying the display video parameters and their control contents in accordance with the camera video parameters altered by the camera unit 2 (step ST2b).

Next, the display video parameter control section 31 alters the values of the display video parameters that are subjected to the control instruction in accordance with the control contents (step ST3b).

Thus controlling the video signal of the camera unit 2 in accordance with the display video parameters controlled enables the display panel 34 to display the video signal in appropriate image quality.

FIG. 7 is a diagram showing an example of the corresponding data indicating correspondence between the camera video parameters and the display video parameters in the embodiment 1. The corresponding data of the parameters shown in FIG. 7 are placed in the display video parameter control section 31 of the host unit 3. As shown in FIG. 7, since the display video parameters and the camera video parameters have similarity, the alteration of the display video parameters is made to follow the alteration of the camera video parameters.

The following are examples of the correspondence between the display video parameters and the camera video parameters.

When the camera control section 21 alters the camera video parameters that prescribe the color tone concerning the AWB setting according to the changes in the surrounding environment, the color space of the image sensor 20 is altered.

For example, when the automatic color control is carried out in a reddish color direction, and unless the host unit 3 controls a display video of the display panel 34, a white subject will be displayed in reddish white.

Thus, since the conventional technique does not alter the display video parameters according to the alteration of the camera video parameters, it carries out the foregoing inappropriate video display.

In contrast with this, according to the present invention, when the camera unit 2 carries out the automatic color control in the direction of red, it transmits to the host unit 3 the camera video parameters concerning automatic color control and the control instruction containing their altered contents so that the display video parameter control section 31 of the host unit 3 controls the color space in the display panel 34 in the phase direction opposite to the color space of the image sensor 20 in accordance with the control instruction. Thus, the display panel 34 can display the white subject in white.

In addition, when the camera control section 21 alters the camera video parameters that prescribe the luminance concerning the AGC setting or BLC setting according to the changes in the surrounding environment, the luminance range of the black and white of the image sensor 20 is altered.

For example, when the maximum value of the white luminance is controlled so as to have slightly grayish luminance, and unless the host unit 3 controls the display video of the display panel 34, a white subject will be displayed in a grayish color.

According to the present invention, when the camera unit 2 carries out the luminance control into gray, it transmits to the host unit 3 the camera video parameters concerning the control and the control instruction containing their altered contents so that the display video parameter control section 31 of the host unit 3 controls the luminance range in the display panel 34 in accordance with the control instruction in the direction opposite to the luminance range of the image sensor 20. Thus, the display panel 34 can display the white subject in white.

Likewise, the display video parameter control section 31 brings the camera video parameters concerning the gamma curve control for carrying out the gamma correction of the video signal of the camera unit 2 into correspondence with the display video parameters concerning the gamma curve control for carrying out the gamma correction of the video signal to be displayed by the host unit 3.

It brings the camera video parameters concerning the filter processing switching of the frequency filter of the camera unit 2 into correspondence with the display video parameters concerning the noise compression control of the host unit 3.

It brings the camera video parameters concerning the contour emphasis step number switching of the camera unit 2 into correspondence with the display video parameters concerning the color contour correction and luminance contour correction of the host unit 3.

It brings the camera video parameters concerning the saturation control of the camera unit 2 into correspondence with the display video parameters concerning the saturation control of the host unit 3.

It brings the camera video parameters concerning the contrast control of the camera unit 2 into correspondence with the display video parameters concerning the contrast control of the host unit 3.

It brings the camera video parameters concerning the sharpness control of the camera unit 2 into correspondence with the display video parameters concerning the sharpness control of the host unit 3.

In addition, according to the value of the camera video parameters, the display control section 33 controls the intensity of the backlight. For example, when it is nighttime and is dark in the vehicle, and if the backlight is at the same intensity of light as in the daytime, it is sometimes perceived that the screen of the display panel 34 is too bright. In this case, in the present invention, when the camera unit 2 alters the camera video parameters according to the environment in the vehicle, the host unit 3 dims the backlight according to that, thereby being able to solve the problem.

As described above, according to the present embodiment 1, it comprises the camera unit 2 including the image sensor 20 for taking an image or video, the camera control section 21 for altering the camera video parameters that prescribe the image sensing conditions and the image quality of the image or video of the image sensor 20 according to the changes in the surrounding environment, and for controlling the image sensing with the image sensor 20 in accordance with the camera video parameters, and the camera video parameter alteration extraction section 23 for extracting the camera video parameters altered by the camera control section 21 and the altered contents, and for issuing the control instruction in conformity with the alteration of the camera video parameters; and the host unit 3 including the display-side communication section 30 for carrying out communication with the camera unit 2, the display control section 33 for displaying on the display panel 34 the image or video of the image sensor 20 received from the camera unit 2 via the display-side communication section 30 in accordance with the display video parameters that prescribe the image quality of the image or video to be displayed on the display panel 34, and the display video parameter control section 31 for controlling, when receiving the control instruction from the camera video parameter alteration extraction section 23 via the display-side communication section 30, the display video parameters corresponding to the camera video parameters the control instruction designates according to the altered contents of the camera video parameters.

Thus the present embodiment 1 establishes the correspondence between the camera video parameters of the camera unit 2 and the display video parameters of the host unit 3. Accordingly, when the camera video parameters are altered owing to the changes in the surrounding environment of the camera unit 2, the display video parameters are also altered according to the changes. As a result, even when the surrounding environment of the camera unit 2 changes, the display panel 34 of the host unit 3 can appropriately display the video taken with the camera unit 2.

For example, a case will be described in which a video, which is taken with the camera unit 2 during moving, is displayed by the host unit 3 as a 3D video. In this case, the camera unit 2 has two image sensors 20 for taking a left-eye image and a right-eye image, respectively, and the host unit 3 displays a 3D video using the left-eye image and right-eye image taken with the image sensors 20. The left-eye image and right-eye image are taken with the image sensors 20 provided on the left and right by simulating viewing the same subject in the same image sensing conditions with the left and right eyes.

Accordingly, when taking the left-eye image and right-eye image continuously in a state in which one of the left and right image sensors 20 is dark because of a shadow of a user, for example, since the image sensing conditions of the two images are not the same, it is likely that the host unit 3 cannot display a normal 3D picture.

In contrast with this, in the present invention, since the host unit 3 controls the display video parameters according to the camera video parameters altered owing to darkening of the surroundings and according to their altered contents, it can carry out appropriate 3D display even in the conditions as described above.

Incidentally, it is to be understood that variations of any components of the individual embodiments or removal of any components of the individual embodiments are possible within the scope of the present invention.

### INDUSTRIAL APPLICABILITY

A display system in accordance with the present invention enables the display device of the host unit to display a video taken with the camera unit appropriately even if the surrounding environment of the camera unit changes. Accordingly, it is suitably applicable to an onboard camera system or the like that will be involved in the changes of the surrounding environment as the vehicle travels.

### DESCRIPTION OF REFERENCE SYMBOLS

1 display system, 2 camera unit (image sensing unit), 3 host unit (display unit), 20 image sensor (image sensing section), 21 camera control section (image sensing-side control section), 21a automatic exposure control section, 21b automatic white balance control section, 21c black level control section, 21d color signal control section, 21e luminance signal control section, 22 camera video parameter storage section, 23 camera video parameter alteration extraction section (alteration extraction section), 24 camera-side communication section (communication section), 30 display-side communication section (communication section), 31 display video parameter control section (control section), 32 display video parameter storage section, 33 display control section (display-side control section), 33a color signal control section, 33b luminance signal control section, 33c backlight dimming section, 34 display panel (display section).

1. A display unit that includes a communication section for carrying out communication with an image sensing unit, that receives an image or video taken with an image sensing section of the image sensing unit via the communication section, and that displays the image or video on a display section, the display unit comprising:
a display-side control section for displaying on the display section the image or video taken with the image sensing section, which is received from the image sensing unit via the communication section, in accordance with a display-side parameter that prescribes image quality of the image or video the display section displays; and
a control section for controlling, when receiving a control instruction relating to alteration of an image sensing-side parameter that prescribes image sensing conditions and image quality of the image or video in an image sensor of the image sensing section from the image sensing unit via the communication section, the display-side parameter in accordance with altered contents of the image sensing-side parameter, wherein the display-side parameter corresponds to the image sensing-side parameter the control instruction designates.

2. The display unit according to claim 1, wherein the display-side parameter comprises at least one of:
a parameter that relates to automatic color control of the image or video to be displayed on the display section, and that corresponds to a parameter concerning an automatic white balance setting of the image sensing section among image sensing-side parameters; and
a parameter that relates to white peak control of the image or video to be displayed on the display section, and that corresponds to a parameter concerning automatic gain control of the image sensing section and to a parameter concerning a black level control setting of the image sensing section among the image sensing-side parameters.

3. The display unit according to claim 2, wherein the display-side parameter comprises at least one of:
a parameter that relates to gamma curve control of the image or video to be displayed on the display section, and that corresponds to a parameter concerning the gamma curve control of the image or video taken with the image sensing section among the image sensing-side parameters;
a parameter that relates to noise compression control of the image or video to be displayed on the display section, and that corresponds to a parameter concerning switching of a frequency filter for the image or video taken with the image sensing section among the image sensing-side parameters;
a parameter that relates to color contour correction of the image or video to be displayed on the display section and a parameter that relates to luminance contour correction of the image or video to be displayed on the display section, which parameters correspond to a parameter concerning contour emphasis step number switching of the image or video taken with the image sensing section among the image sensing-side parameters;
a parameter that relates to HUE control of the image or video to be displayed on the display section, and that corresponds to a parameter concerning HUE control of the image or video taken with the image sensing section among the image sensing-side parameters;
a parameter that relates to saturation control of the image or video to be displayed on the display section, and that corresponds to a parameter concerning saturation control of the image or video taken with the image sensing section among the image sensing-side parameters;
a parameter that relates to contrast control of the image or video to be displayed on the display section, and that corresponds to a parameter concerning contrast control of the image or video taken with the image sensing section among the image sensing-side parameters; and
a parameter that relates to sharpness control of the image or video to be displayed on the display section, and that corresponds to a parameter concerning sharpness control of the image or video taken with the image sensing section among the image sensing-side parameters.

4. The display unit according to claim 1, wherein
the display section is a liquid crystal display section including a backlight; and
the display-side control section dims the backlight in accordance with alteration of the image sensing-side parameter in the image sensing unit.

5. An image sensing unit that includes an image sensing section for taking an image or video and a communication section for carrying out communication with a display unit, and that transmits the image or video taken with the image sensing section to the display unit via the communication section and causes a display section to display the image or video, the image sensing unit comprising:
an image sensing-side control section for altering an image sensing-side parameter according to changes in a surrounding environment, and for controlling image sensing of the image sensing section in accordance with an image sensing-side parameter, wherein the image sensing-side parameter prescribes image sensing conditions and image quality of the image or video in an image sensor of the image sensing section; and
an alteration extraction section for extracting the image sensing-side parameter and altered contents altered by the image sensing-side control section, and for providing a control instruction to the display unit via the communication section to control a display-side parameter in accordance with the altered contents, wherein the display-side parameter corresponds to the image sensing-side parameter altered and prescribes image quality of the image or video the display section displays.

6. A display system comprising:
an image sensing unit including an image sensing section for taking an image or video, an image sensing-side control section for altering an image sensing-side parameter that prescribes image sensing conditions and image quality of the image or video in an image sensor of the image sensing section according to changes in a surrounding environment and for controlling image sensing of the image sensing section in accordance with the image sensing-side parameter, and an alteration extraction section for extracting the image sensing-side parameter, which has been altered by the image sensing-side control section, and altered contents, and for issuing a control instruction in accordance with the alteration of the image sensing-side parameter; and
a display unit including a communication section for carrying out communication with the image sensing unit, a display-side control section for displaying the image or video, which is taken with the image sensing section and is received from the image sensing unit via the communication section, on a display section in accordance with a display-side parameter that prescribes image quality of the image or video the display section displays, and a control section for controlling, when receiving the control instruction from the alteration extraction section via the communication section, the display-side parameter according to the altered contents of the image sensing-side parameter, wherein the display-side parameter corresponds to the image sensing-side parameter the control instruction designates.
